(19) United States
(12) Patent Application Publication
(10) Pub. No.: US 2005/0212685 A1
(43) Pub. Date: Sep. 29, 2005

(54) Talking remote appliance-controller for the blind

(76) Inventor: Gary Babcock Gordon, Saratoga, CA (US)

Correspondence Address: Gary Gordon, 21112 Bank Mill Rd., Saratoga, CA, 95070, US

(21) Appl. No.: 10/812,675

(22) Filed: Mar. 29, 2004

(51) Int. Cl. H04Q 1/00

(52) U.S. Cl. 340/825.19; 340/825.72; 348/734; 348/14.05; 340/692

(57) ABSTRACT

A remote control for the visually impaired provides improved control over televisions and other appliances. The remote control has an input module, which may be a keypad, for receiving user inputs. The remote control further has a wireless transmitter module for sending control signals to an appliance being controlled. The remote control further has a speech module for uttering speech signals indicative of the user input. In an optional learning mode, the remote control only utters commands as they are entered, and does not transmit the commands. In another optional mode, the remote control only transmits control signals, and does not utter the corresponding speech signals. By the remote control providing both training and also feedback, blind users become better able to operate their complicated appliances independently, with fewer mistakes, and with less intervention.

### BACKGROUND

According to statistics collected by the University of Washington Department of Ophthalmology, 1,100,000 people in the United States are legally blind, and an additional 10,300,000 have vision conditions which are not correctable by glasses. Television remains an important part of their lives, in spite of their disabilities, thanks in part to accommodative provisions such as the secondary audio program (SAP). However, operating their television sets has become increasingly difficult, because these provisions and other added functionality have added considerable complexity to their remote controllers.

One partial solution to the problem is a class of after-market remote controllers with fewer and larger keys or buttons, although they were primarily designed to help people with limited muscle control. Nonetheless, for the partially sighted, their larger keys are advantageously easier to read. However, for the completely blind, while the keys might be easier to locate by feel, their reduced number can prevent their accessing important functions such as, the SAP.

Another aftermarket remote controller which specifically designed for the blind, and manufactured by Innotech Systems Incorporated, can be trained to recognize individual voice commands spoken by the user. However, such technology requires protracted training by the user for each and every command, it requires different training for different voices; it may not work if the user acquires a cold, it requires the user to remember exact commands as for example whether the phrase to turn down the volume was “volume down” or “lower” or “quieter”, it does not have a convenient way to hold a key down as for example to arbitrarily increase the volume, it is not inconspicuous to use, and it does not help the user learn the layout of its keys.

In summary, the earliest remote controllers for television sets did not present blind people with all these problems of complexity. These controllers were simple to operate, since they only provided the capability to adjust volumes and change channels. In contrast, today's remote controllers may have fifty or more keys, allowing one to control everything from which antenna or which video source is active, to displaying pictures within pictures, to setting up other appliances such as VCRs and DVDs. For the blind, such complexity means if they unintentionally press a wrong key, they can precipitate a problem they can't fix, such as inadvertently disabling their antenna or program source. In their anxiousness to correct the problem they might then press other wrong keys. Eventually, despite priding themselves in being able to live independently, they need to turn to someone sighted for help. What the blind community needs is a remote controller that is capable of full control over their complex entertainment and other appliances, yet is nonetheless easy to learn and operate.

### SUMMARY OF THE INVENTION

The present invention is an improved hand-held remote controller for the blind and visually impaired. It facilitates their controlling their television sets, entertainment-center components, and other appliances and systems such as lighting, air conditioning, and security. It makes special use of voice feedback for several purposes. As practiced in the invention, such voice feedback in part helps train users on the layout of their keypads. Further, it helps minimize their mistakes by optionally confirming the functions of keys before any commands are transmitted. Further still, it helps users recover if they still make mistakes, since they will know from having heard utterances, which wrong commands were transmitted.

The controller is equipped with a user input module for receiving user input commands. For example, the input module might be a keypad, and in the instance of an entertainment center controller, an input command might be to turn the volume up higher, of fast-forward a tape. Coupled to the input module is a transmit module which contains in part a wireless transmitter, which for example may be an infrared transmitter. The transmit module is operable in response to user input commands, and transmits remote-control command signals to the appliance or appliances being controlled. Also coupled to the input module is a speech module, which generates speech signals corresponding to keys on the keypad. The speech module signals can send speech signals to an audio transducer such as a speaker or an earphone, such that a user receives aural confirmations as to which user inputs was actually made, to determine whether or not they were the intended ones.

In one embodiment of the invention, while in a training mode, command signals are inhibited from being transmitted, though speech signals corresponding to keys a user has pressed are announced by the transducer of the remote controller. These announced speech signals give aural confirmation that the user input was indeed the one intended. While in an operating mode, both the speech are uttered and the control signals are transmitted.

By receiving aural confirmation of their user inputs, blind users of the present invention derive three salient benefits. First, by having a training aid, it is possible for them to spend time alone, memorizing the functions and locations of keys on their controllers. Second, by being able to optionally hear aural confirmations as utterances as to their user inputs, before committing to transmit them, the likelihood is greatly reduced of their making mistakes whether caused by a slip of memory or a slip of the finger. Third, should a mistake happen anyway, by knowing which command was actually transmitted, they will better be able to correct the situation themselves. These collective benefits of the invention serve to both help the self-esteem and also to support the independent living of persons without sight.

### BRIEF DESCRIPTION OF THE DRAWINGS

FIG. 1 is a block diagram of the remote control device of the invention.

FIG. 2 is a block diagram of an exemplary embodiment of a remote control device in accordance with the invention.

FIG. 3 is a block diagram of another exemplary embodiment of a remote control device in accordance with the invention.

FIG. 4 is an isometric view of an exemplary embodiment of a remote control device in accordance with the invention.

FIG. 5 is a schematic drawing of the circuitry of the embodiment shown in FIG. 1.

FIG. 6 is a timing diagram showing representative digital command signals.

FIG. 7 is a flow chart and state diagram of the embodiment shown in FIG. 1.

### DESCRIPTION OF A PREFERRED EMBODIMENT

FIG. 1 shows the elements of an exemplary embodiment of the present invention, a universal remote control apparatus 1 that controls the operation of such appliances as a television set, a digital disc player (DVD), a VCR, and a cable box. By controlling a number of appliances with a single controller instead of several, a blind user advantageously only needs to learn one keyboard layout.

User inputs are received by a user input module 2, which may for example be a keypad. If the user input module is a keypad, then user inputs may be made by pressing keys.

Associated with some of the keys are control signals 7 and also speech signals 6. Control signals are transmitted by a wireless transmitter in a transmit module 5. These user inputs may additionally or alternatively cause an associated speech signal 6 to be uttered by a speech module 4. For example, if the remote control had a keypad on which one key was marked “volume-up”, and a user pressed that key as a user input, then the remote control 1 would cause a control signal 7 to be sent to the appliance being controlled, such as to direct the appliance to increase its volume. Further, the remote control would also utter the speech signal “volume-up”, as confirmation for a blind user as to which key had actually been pressed.

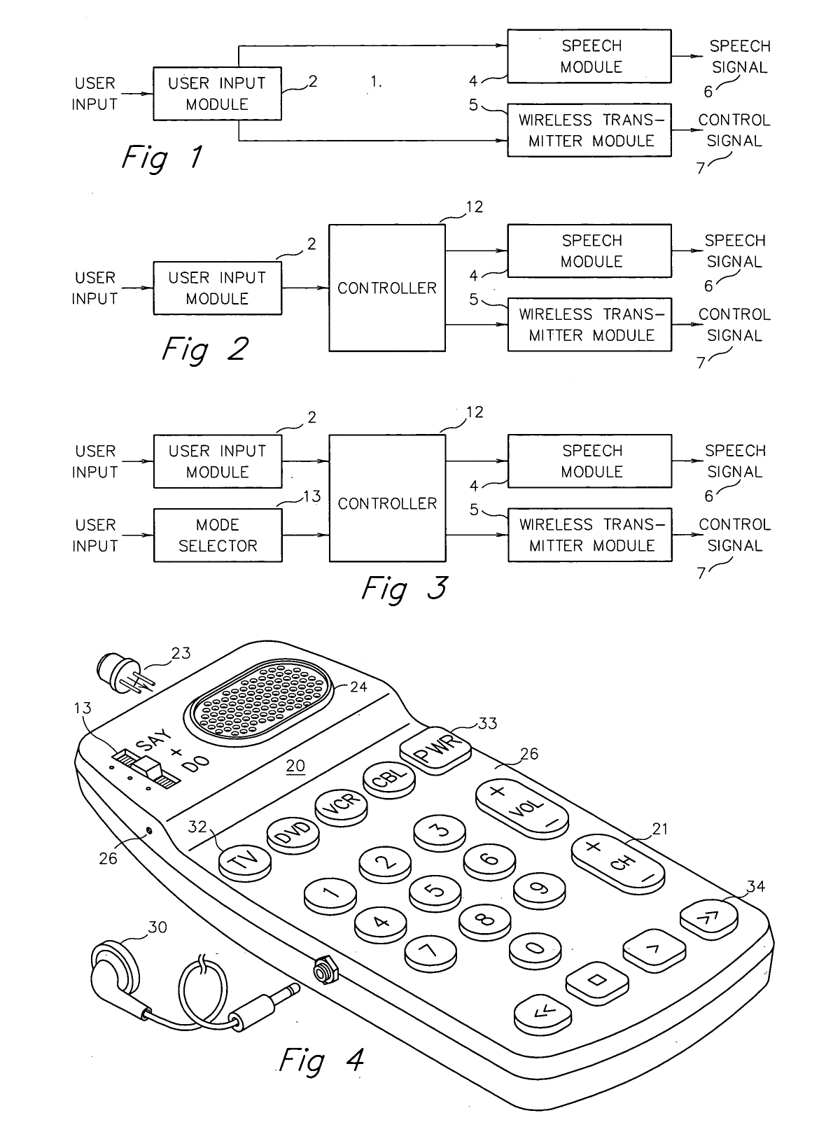

FIG. 2 shows a second exemplary embodiment that builds upon the technology of the exemplary first embodiment shown in FIG. 1. It shows a controller 12 electrically connected to the user input module 2, the transmit module 5, and the speech module 4. The controller 12 receives user input from the user input module 2, and, in response to the user input, causes the transmitter module 5 to transmit a remote control signal 7 corresponding to the user input. Further, the controller 12 causes the speech module 4 to generate a speech signal 6 indicative of the user operation.

FIG. 3 shows a third exemplary embodiment that builds upon the exemplary embodiment shown in FIG. 2, and shows a mode selector 13 connected to the controller 12. The mode selector 13 receives additional user inputs indicative of the user's desire to have the remote control produce speech signals, control signals, or both.

FIG. 4 reveals details of an exemplary embodiment 20 that is shown mounted in a housing. The user input module is a keypad 26 mounted to the housing, which contains 23 momentary-contact push-button key switches 32. Operating any of the four keys labeled TV, DVD, VCR, and CBL sets an internal state of the remote control, such that subsequent user inputs will pertain to controlling that particular appliance, as for example the television set. For example, if the TV key 32 had been pressed, then subsequently pressing the power key 33 would cause actions to happen that are associated only with the television set, such as turning it on or off. Several keys only have relevance for certain of the appliances, as for example the fast-forward key 34 having meaning only should the state of the remote control be set to DVD or VCR.

Associated with the power key 33 and each of the other command keys such as the channel selector 21 and the ten digits, are control signals and speech signals.

The consequences of entering a user input depend on not only the appliance being controlled, but also the mode of operation of the remote control 20, as determined by its mode selector 13. The mode selector in the exemplary embodiment is a three-position slide-switch. For example, if the mode selector 13 is in the position closest to the operator, shown marked “DO” in FIG. 3, then user inputs corresponding to and associated with each key switch are sent to the appliance being controlled. This transmission is accomplished by the transmit module 5 transmitting an infrared light emitting diode (LED) 23 control signal 7 to the appliance being controlled. When the remote control 20 is thus set to it's “DO” mode, the generation and uttering of speech signals is inhibited.

On the other hand, if the mode selector 22 is in the position furthest from the operator, in the position marked “SAY”, the remote control is in a training mode, where user inputs instead cause the speech module 4 to produce speech signals 6 which correspond to and are associated with each key. For example, pressing the VOL+key might produce the speech signal of “volume up”, or “louder”. In the exemplary embodiment, speech signals 6 are transduced by a speaker 24 or alternatively an optional earphone 30. When the remote control 20 is thus set to it's “SAY” mode, the generation or transmission of control signals is inhibited.

In a third mode of operation, when the mode selector 22 is in its center position, both the speech module 4 and the transmit module 5 are operative. In this mode, a user input causes both speech signals to be uttered, and also the control signals to be generated and transmitted to the appliance being controlled.

In the exemplary embodiment, the speech signals associated with each of the user inputs are as follows:

| | | | |
|---|---|---|---|
| “Say” | “Television” | “Power” | “Rewind” |
| “Say and Do” | “DVD” | “Louder” | “Stop” |
| “Do” | “Tape” | “Quieter” | “Play” |
| “One” thru “Zero” | “Cable” | “Channel Up” | “Fast Forward” |
| | | “Channel Down” | |

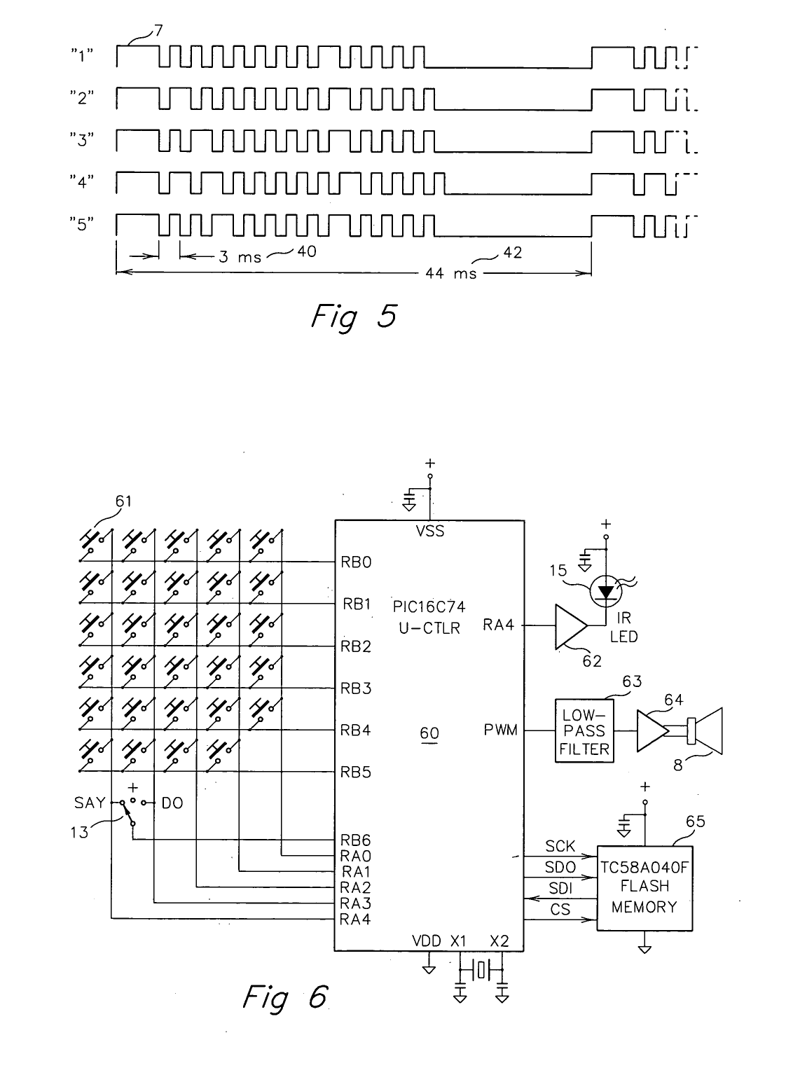

FIG. 5 shows representative control signals 7 that are sent via the infrared LED 15 to the appliance being controlled in one embodiment. Different manufacturers use different codes for these control signals, so these signals should be considered only representative. However, they are the actual control signals used by the Sony Corporation to transmit the digits 1 through 5 to their television sets. Other manufacturers' control signals follow the same general format, that of code sequences using a clock period 40 of approximately 3 ms, and a repetition interval 42 of approximately 44 ms.

Although the different control signals in use number in the thousands, any particular appliance manufacturer will usually standardize on one code set for each of their types of appliances, such as their television sets. While these individual appliance code sets may be obtained from each manufacturer, the number of such appliance code sets is in the hundreds, so it more expedient to purchase them as a file from a specialized supplier such as Innotech Systems Incorporated. Convention is to use a three-digit code-set identifier for each appliance code set. For example, the code set identifier the Sony Corporation uses for their television sets is 001. Since the remote control 20 will not know in advance which appliances are to be controlled, and therefore which code sets will be needed, it will typically store all of the common code sets. It then becomes up to the user to configure his or her remote control 20 such that, in the present example, control signals 7 sent to their television set will drawn be from the code whose code set identifier is 001.

To prevent inadvertent disruption of the code-set identifiers once they have been entered, use is made of a recessed control switch 26. Entering a code-set identifier is accomplished by using this recessed switch, and other keys 32 on the keypad 26. In the present example, entering the code set identifier 001 for a television set would involve operating in sequence first the recessed switch 26, then the “TV” key, the “0” key, the “0” key and finally the “1” key.

FIG. 6 shows a schematic drawing of the preferred embodiment. In this example, the microcontroller 60 is of the Microchip Technologies Inc. PIC16C77X family. Because its standby current is less than one microampere, it may be continuously powered without compromising battery life (two “AA” batteries not shown). The microcontroller 60 scans the control keys 61 on the keypad 26 in a conventional manner (the “VOL” and “CH” are each double keys).

Digital representations of control signals 7 are recalled from a flash memory 65, which in this example is a Toshiba TC58A040F integrated circuit. They are amplified by an amplifier 62, and transmitted via an infrared diode 15. Amplifier 62 is preferably a switching amplifier, so as to maximize efficiency and prolong life. The most common amplifier switching frequency is 40 kHz. The control signals 7 transmitted by the LED 15 thus have their high state represented by strings of 40 kHz infrared light pulses. Another advantage of pulse modulation is that is facilitates band-pass filtering in the receiving appliance, which increases its immunity to ambient room light.

In the exemplary embodiment, the speech signals are stored as digitized representations of waveforms or wave files. The wave files are obtained by sampling spoken speech. The sampling is performed at a sampling frequency of 8 kHz, and with a resolution of ten bits. The sampled waveforms are stored in the same flash memory 65 as the control signals and other internal states of the remote controller such as which appliance is currently being controlled.

A pulse-width modulator (PWM) in the microcontroller converts these digital wave files into speech signals 6. The modulator's output is first filtered by a low-pass filter 63 having a cutoff frequency of 3 KHz, and then is amplified by an audio amplifier 64, and finally transduced into audible speech signals by a speaker 8 or other audio transducer such as for example an earphone 9. Not shown is an optional volume control.

Speech signals mean electronic signals, and also mean audible signals. Audible signals are also referred to as utterances.

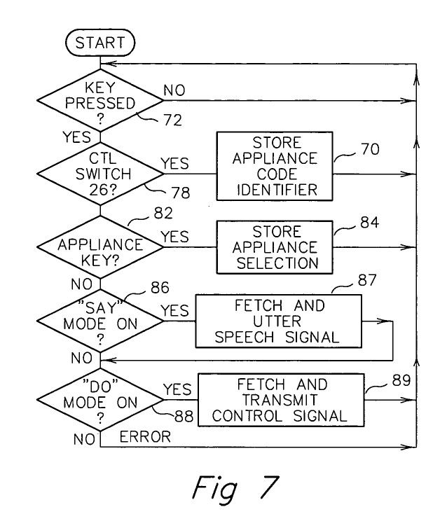

FIG. 7 shows a flow chart for the exemplary embodiment. It consists of a state machine that is driven by keystrokes. Some keystrokes set internal states, while others cause control signals to be transmitted or cause wave files to be uttered. Any key press 72 causes the chain of decision blocks 78, 82, 86, and 88 to make this determination.

For example, pressing the control key switch 26 will cause the flow to leave the key press test block 72, and be recognized by the switch 26 test in block 78. Having been so selected, the flow will proceed rightwards entering block 70, which contains a subroutine (not shown) that will store the three-digit code-set identifier in memory 65.

Similarly, pressing one of the appliance identifier keys TV, DVD, VCR, or CBL will cause the flow to branch at decision test block 82, and cause block 84 to store that state as well in memory 65.

On the other hand, pressing one of the remaining keys will cause the flow to branch either at the “say” decision test 86, or the “do” decision test 88, or both if the mode switch 13 is set to its middle “+” position. If the “say” mode is active, then the fetch-and-utter block 87 will cause the speech module 4 to generate a speech signal 6. Similarly, if the “do” mode is active, then the fetch-and-transmit block 89 causes the transmit module 5 to transmit a control signal 7.

While the exemplary embodiment described so far is a universal remote control which is capable of controlling more than one appliance, other exemplary embodiments may control just a single appliance such as television set or VCR. Also, while the previous exemplary embodiment is shown controlling appliances in an entertainment center, other embodiments may control other household appliances, such as security alarms, heating and air conditioning, or lighting. For example, a talking remote control could send set-point temperatures to a thermostat, with the benefit that a user would have assurance that the intended temperature was actually the one set. Other exemplary embodiments may equally well control home control systems, such as the X10™ system.

Although the control signals sent by the transmit module of the exemplary embodiment are infrared signals, they may alternatively be signals in any other segments of the electromagnetic spectrum, such as the visible or radio, e.g., HF, VHF or UHF.

While a slide switch mode selector 13 has been shown to set the speaking and controlling modes of the remote control, many other switching techniques may be used as well. For example, the slide switch may be replaced with other forms of switches such as push-button switches or gravity switches.

While the mode selector has been shown connected to the controller, the mode switch could alternatively be connected so as to inhibit speech or control signals by inhibiting either the speech module 4 or the transmitter module 5, or by inhibiting the speech signal 6 or the control signal 7. For example, the mode switch could electrically break the electrical connection somewhere between the controller and an audio transducer such as speaker, or it could electrically break the connection somewhere between the controller and the infrared LED or other transmitter, or it could break connections at any place which would accomplish the desired effect.

While several modes of operating the invention have been described in the exemplary embodiment, many others are practical. In other exemplary embodiments, an additional user input is required before a module will operate. For example, operating a key or other switch might be required before the speech module would operate, or before the wireless transmitter module would operate. As a more specific example, it might be required that in order to produce a speech signal while transmitting a control signal, a user needs to simultaneously hold down a speech key. As a variation of this example, it might be required that a user be required in order to produce a speech signal, to momentary first press a speech key. As another more specific example, a user might be required to simultaneously operate a mute key if a speech signal is not desired. It should be evident that other mode options could be applied to operating the speech module, and to operating the wireless transmitter module as well.

In still another embodiment using no mode switches at all, the remote control always generates speech and control signals, though a user could block either with their hand, or turn down a volume control or switch. In yet other embodiments, the user's first pressing of any a command key might produce speech signals alone, while an immediate second pressing produced both speech and transmitted control signals. In this way they would receive an aural confirmation that they had located the intended key, such that a second operation of the key would be known to transmit the intended command.

While one exemplary embodiment has been described including a speech transducer such as a speaker or an earphone, these transducers can be replaced with just a connector for outputting the speech signal, allowing a user to attach their own earphone, powered speaker, or other transducer.

Other variations of the invention use alternative methods of storing and generating spoken language, including speech synthesis, storing syllables instead of words, and storing words common to several announcements such as the word “channel” in “channel-up” and “channel-down”.

This disclosure describes the invention in detail using illustrative embodiments. However it is to be understood that the invention defined by the appended claims is not limited to the embodiments described.

1. A remote control apparatus, comprising:
a user input module;
a wireless transmitter module coupled to the user input module, the transmitter operable in response to user operation of the user input module to transmit a remote control signal corresponding to the user operation; and
a speech module coupled to the user input module, the speech module operable to generate a speech signal indicative of the user operation.

2. The apparatus of claim 1, additionally comprising a controller electrically connected to the user input module, the transmitter module, and the speech module.

3. The apparatus of claim 2, additionally comprising a selector electrically connected to the controller, the selector operable to select an operational mode of the apparatus.

4. The apparatus of claim 3, in which the operational modes comprise an operational mode in which operation of the transmitter is inhibited.

5. The apparatus of claim 3, in which the operational modes comprise an operational mode in which operation of the speech module is inhibited.

6. The apparatus of claim 3, in which the operational modes comprise an operational mode in which one of the modules requires an additional user input before operating, and the other module operates without additional input from the user.

7. The apparatus of claim 1, additionally comprising a speech transducer connected to receive the speech signal.

8. A method of remotely controlling an appliance, the method comprising:
receiving user input; and
in response to the user input:
wirelessly transmitting a remote control signal corresponding to the user input, and
generating a speech signal indicative of the user input.

9. The method of claim 8, additionally comprising selecting an operational mode of the controlling.

10. The method of claim 9, additionally comprising inhibiting the transmitting in the selected operational mode.

11. The method of claim 9, additionally comprising inhibiting the generating of speech in the selected operational mode.

12. The method of claim 8, additionally comprising uttering audible speech in response to the speech signal.

13. The method of claim 12, additionally comprising:
selecting an operational mode of the controlling; and
in the selected operational mode:
receiving additional user input after the uttering, and
triggering the transmitting by the additional user input.

14. Apparatus for remotely controlling an appliance, the apparatus comprising:
a user input module;
a wireless transmitter module;
a speech module; and
control means, coupled to the user input module, the transmitter and the speech module, for receiving user input from the user input module and, in response to the user input, for causing the transmitter to transmit a remote control signal corresponding the user input and for causing the speech module to generate a speech signal indicative of the user operation.

15. The apparatus of claim 14, additionally comprising a speech transducer connected to the control means to receive the speech signal.

16. The apparatus of claim 14, in which the user input device comprises a selector operable to select an operational mode of the apparatus.

17. The apparatus of claim 16, in which, in the selected operational mode, the control means is additionally for inhibiting the transmitter.

18. The apparatus of claim 16, in which, in the selected operational mode, the control means is additionally for inhibiting the speech module.

19. The apparatus of claim 16, in which, in the selected operational mode, the control means is additionally awaiting an additional user input from the user input module before it causes the transmitter to transmit the control signal.

20. A remote control apparatus, comprising:
an array of user-operable switches;
an infrared transmitter;
an audio transducer; and
electronic storage;
wherein:
associated with each of the switches and stored in the electronic storage is a respective speech signal and a respective control signal capable of controlling an appliance, and
operating one of the switches causes the speech signal associated therewith to be uttered by the audio transducer to provide aural confirmation as to the switch that was operated, and causes the control signal associated therewith to be transmitted by the infrared transmitter.

21. The apparatus of claim 20, wherein the uttering of the speech signal and the transmitting of the control signal do not happen concurrently.

22. The apparatus of claim 20, wherein one of the user-operable switches can inhibit the speech signal.

23. The apparatus of claim 20, wherein one of the user-operable switches can inhibit the transmitting of the control signal.

24. The apparatus of claim 20, wherein one of the control signals is capable of controlling a television.

25. The apparatus of claim 20, wherein the audio transducer comprises at least one of a speaker and an earphone.

26. The apparatus of claim 20, wherein the said control signals are capable of controlling more than one type of appliance.
